(19) United States
(12) Patent Application Publication
(10) Pub. No.: US 2015/0069834 A1
(43) Pub. Date: Mar. 12, 2015

(54) OPERATING METHOD OF INVERTER - CHARGER INTEGRATION APPARATUS FOR ELECTRIC VEHICLE

(71) Applicant: LSIS CO., LTD., Anyang-si (KR)

(72) Inventors: Jae Hoon JANG, Seoul (KR); Byung Woon JANG, Seoul (KR); Joong Ki JUNG, Seoul (KR)

(73) Assignee: LSIS CO., LTD., Anyang-si (KR)

(21) Appl. No.: 14/477,159

(22) Filed: Sep. 4, 2014

(30) Foreign Application Priority Data
Sep. 9, 2013 (KR) 10-2013-0108131

(51) Int. Cl. B60L 11/18

(52) U.S. Cl. CPC B60L 11/1838; B60L 11/1811; B60L 11/1803
USPC 307/10.1

(57) ABSTRACT

An operating method of an inverter-charger integration device for an electric vehicle is disclosed. In the operating method, whether a charge switch and a controller area network (CAN) communication module are used is confirmed. When both the charge switch and the CAN communication module are in use, an operation mode of an inverter is determined by using a first table. When only the charge switch is in use, the operation mode of the inverter is determined by using a second table. When only the CAN communication module is in use, the operation mode of the inverter is determined by using a third table. When both the charge switch and the CAN communication module are not in use, the operation mode of the inverter is determined by using a fourth table.

### CROSS-REFERENCE TO RELATED APPLICATIONS

Pursuant to 35 U.S.C. §119(a), this application claims the benefit of earlier filing date and right of priority to Korean Patent Application No. 10-2013-0108131, filed Sep. 9, 2013, the contents of which are all hereby incorporated by reference herein in its entirety.

### BACKGROUND

The present disclosure relates to an operating method of an electric vehicle, and particularly, to an operating method of an inverter-charger integration apparatus charging a battery prepared in the electric vehicle and including an inverter for driving three-phase motor.

Typically, an electric vehicle includes, for example, a high voltage battery in which a high voltage of about 72V is charged, a three-phase motor driven with power charged in the high voltage battery to run the electric vehicle, and an inverter for driving the three-phase motor. Driving the three-phase motor with the power charged in the high voltage battery is limited according to capacity of the high voltage battery.

When the power remained in the high voltage battery of the electric vehicle is lowered to a predetermined amount or less, the three-phase motor is not any longer driven. Accordingly, the electric vehicle may include a high voltage charger and charge the high voltage battery.

Such a high voltage charger is largely classified into a low speed charger using a single-phase AC power supply for household power supplies and a high speed charger using three-phase AC power supply for transmission and distribution.

Furthermore, each of the inverter, high voltage charger, and low voltage charger are prepared as mutually separated from each other and lots of time and man power are consumed to design each of them to be mounted in the electric vehicle. Accordingly, an inverter-charger integration apparatus for an electric vehicle in which each of the above-described devices are integrated into one is being developed.

However, various issues occur by integrating the above-described two functions into one.

In particular, due to user's carelessness, the three-phase motor may operate during a charging operation and there is difficulty in mode selection between the charging operation and a driving operation.

That is, the inverter-charger integration apparatus for an electric vehicle simply performs the charging operation or the driving operation according to a state of an external switch. However, a vehicle that does not use such an external switch has difficulty in the operation selection.

In addition, since an external switch is to be separately installed for the operation selection, additional manufacturing processes are necessary and a unit cost increases. Moreover, since a solution for the case where a driver drives a motor during a charging operation is not prepared, he/she may be damaged.

### SUMMARY

Embodiments provide an operating method of an inverter-charger integration apparatus for an electric vehicle capable of selecting an operation mode of the inverter-charger integration apparatus by combining various elements without depending on an external switch.

Technical tasks obtainable from the present invention are not limited to the above mentioned technical tasks. And, other unmentioned technical tasks can be clearly understood from the following description by those skilled in the art to which the present invention pertains.

In one embodiment, an operating method of an inverter-charger integration device for an electric vehicle includes: confirming whether a charge switch and a controller area network (CAN) communication module are used; when both the charge switch and the CAN communication module are in use, determining an operation mode of an inverter by using a first table; when only the charge switch is in use, determining the operation mode of the inverter by using a second table; when only the CAN communication module is in use, determining the operation mode of the inverter by using a third table; and when both the charge switch and the CAN communication module are not in use, determining the operation mode of the inverter by using a fourth table.

The determining of the operation mode of an inverter by using the first table may include: confirming states of an ignition key switch and the charge switch; when at least one of the states of the ignition key switch and the charge switch is a first state corresponding to an On-state, providing driving power to the inverter; when the driving power is provided, confirming the state of the charge switch, a state of the CAN communication module, and an input state of AC power; and determining the operation mode of the inverter according to the confirmation result.

The determining of the operation mode of the inverter according to the confirmation result may include: determining the operation mode of the inverter according to the confirmed states; when the state of the charge switch is the first state corresponding to the On-state, a communication state of the CAN communication module is a first state where a charge request communication message is received, or the input state of the AC power is a first state where normal AC power is input; when at least one of the state of the charge switch, the communications state of the CAN communication module, and the input state of the AC power is the first state, determining the operation mode of the inverter to a charging mode; and when all of the state of the charge switch, the communication state of the CAN communication module, and the input state of the AC power are the second state which is opposite to the first state, determining the operation mode of the inverter to a driving mode.

The determining of the operation mode of the inverter by using the second table may includes: confirming a state of the ignition key switch and the state of the charge switch; when at least one of the states of the ignition key switch and the charge switch is a first state corresponding to an On-state, providing driving power to the inverter; when the driving power is provided, determining whether the state of the charge switch is the first state corresponding to the On-state, or an input state of the AC power is a first state where normal AC power is input; when at least one of the state of the charge switch and the input state of the AC power is the first state, determining the operation mode of the inverter to a charging mode; and when both the state of the charge switch and the input state of the AC power is the second state, which is opposite to the first state, setting the operation mode of the inverter to a driving mode.

The determining of the operation mode of the inverter by using the third table may include: confirming an ignition key switch; when a state of the ignition key switch is a first state corresponding to an On-state, providing driving power to the inverter; when the driving power is supplied, determining whether a communication state of the CAN communication module is a first state in which a charge requesting communication message is received or a second state in which the AC power is normally input; when at least one of the CAN communication module and the input state of the AC power is the first state, determining the operation mode of the inverter as a charging mode; and when both the CAN communication module and the input state of the AC power are the second state which is opposite to the first state, setting the operation mode of the inverter as a driving mode.

The determining of the operation mode of the inverter by using the fourth table may include: confirming an ignition key switch; when a state of the ignition key switch is a first state corresponding to an On-state, providing driving power to the inverter; when the driving power is supplied, confirming the input state of the AC power; when the input state of the AC power is in a first state where the AC power is normally input, determining the operation mode of the inverter as a charging mode; when the input state of the AC power is a second state which is opposite to the first state, setting the operation mode of the inverter as a driving mode.

The operation method may further include, when the operation mode of the inverter is determined as the charging mode, providing charge power to a high voltage battery by using the inverter.

The providing of the charge power may include: confirming a gear shift state; when the confirmed gear shift state is neutral, operating the inverter and providing the charge power to the high voltage battery; and when the confirmed gear shift state is another state except the neutral state, stopping the operation of the inverter and stopping the charging operation.

The operation method may further include, when the confirmed gear shift state is another state except the neutral state, outputting a warning message, wherein the warning message comprises a message requesting a state change of the gear shift for starting to charge the high voltage battery.

The first table may be configured with the operation mode of the inverter to be determined according to combination of a state of an ignition key, a communication state of the CAN communication module and an input state of AC power, the second table may be configured with the operation mode of the inverter to be determined according to the state of the ignition key switch, the state of the charge switch, and the input state of the AC power, the third table may be configured with the operation mode of the inverter to be determined according to the state of the ignition key switch, the communication state of the CAN communication module and the input state of the AC power, and the fourth table may be configured with the operation mode of the inverter to be determined according to the state of the ignition key switch and the input state of the AC power.

The details of one or more embodiments are set forth in the accompanying drawings and the description below. Other features will be apparent from the description and drawings, and from the claims.

### BRIEF DESCRIPTION OF THE DRAWINGS

FIG. 1 illustrates a configuration of an inverter-charger integration apparatus for an electric vehicle according to an embodiment.

FIG. 2 illustrates a first table according to an embodiment.

FIG. 3 illustrates a second table according to an embodiment.

FIG. 4 illustrates a third table according to an embodiment.

FIG. 5 illustrates a fourth table according to an embodiment.

FIG. 6 is a flowchart explaining, for each step, an operating method of an inverter-charger integration apparatus for an electric vehicle according to a first embodiment.

FIG. 7 is a detailed flowchart of operation 106 of FIG. 106.

FIG. 8 is a flowchart explaining, for each step, an operating method of an inverter-charger integration apparatus for an electric vehicle according to a second embodiment.

FIG. 9 is a flowchart explaining, for each step, an operating method of an inverter-charger integration apparatus for an electric vehicle according to a third embodiment.

FIG. 10 is a flowchart explaining, for each step, an operating method of an inverter-charger integration apparatus for an electric vehicle according to a fourth embodiment.

FIG. 11 is a flowchart explaining, for each step, an operating method of an inverter-charger integration apparatus for an electric vehicle in a charging mode.

FIG. 12 is a flowchart explaining, for each step, an operating method of an inverter-charger integration apparatus for an electric vehicle in a driving mode.

### DETAILED DESCRIPTION OF THE EMBODIMENTS

Reference will now be made in detail to the embodiments of the present disclosure, examples of which are illustrated in the accompanying drawings.

Advantages and features of the present invention, and methods for achieving the same will be cleared with reference to exemplary embodiments described later in detail together with the accompanying drawings. However, the present invention is not limited to the following exemplary embodiments, but realized in various forms. In other words, the present exemplary embodiments are provided just to complete disclosure the present invention and make a person having an ordinary skill in the art understand the scope of the present invention. The present invention should be defined by only the scope of the accompanying claims. Throughout this specification, like numerals refer to like elements.

When it is determined detailed description related to a related known function or configuration that may make the purpose of the present invention unnecessarily ambiguous in describing embodiments of the present invention, the detailed description will be omitted here. Also, terms used herein are defined to appropriately describe the exemplary embodiments of the present invention and thus may be changed depending on a user, the intent of an operator, or a custom. Accordingly, the terms must be defined based on the following overall description of this specification.

It is to be understood that blocks in the accompanying block diagrams and compositions of steps in flowcharts can be performed by computer program instructions. These computer program instructions can be provided to processors of, for example, general-purpose computers, special-purpose computers, and programmable data processing apparatuses. Therefore, the instructions performed by the computer or the processors of the programmable data processing apparatus generate means for executing functions described in the blocks in block diagrams or the steps in the flowcharts. The computer program instructions can be stored in a computer available memory or a computer readable recording medium of the computer or the programmable data processing apparatus in order to realize the functions in a specific manner. Therefore, the instructions stored in the computer available memory or the computer readable recording medium can manufacture products including the instruction means for performing the functions described in the blocks in the block diagrams or the steps in the flowcharts. Also, the computer program instructions can be loaded onto the computer or the computer programmable data processing apparatus. Therefore, a series of operational steps is performed in the computer or the programmable data processing apparatus to generate a process executed by the computer, which makes it possible for the instructions driving the computer or the programmable data processing apparatus to provide steps of executing the functions described in the blocks of the block diagrams or the steps of the flowcharts.

Each block or each step may indicate a portion of a module, a segment or a code including one or more executable instructions for performing a specific logical function (or functions). It should be noted that, in some modifications of the present invention, the functions described in the blocks or the steps may be generated out of order. For example, two blocks or steps continuously shown can be actually performed at the same time, or they can be performed sometimes in reverse order according to the corresponding functions.

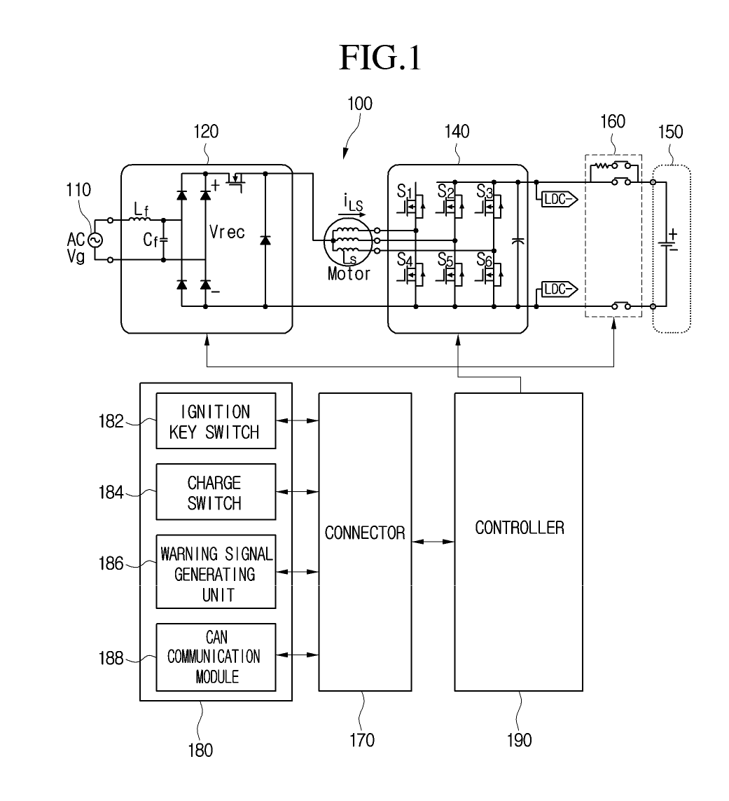

FIG. 1 illustrates a configuration of an inverter-charger integration apparatus for an electric vehicle.

Referring to FIG. 1, the inverter-charger integration apparatus includes an AC power supply 110, a rectifier 120 rectifying AC power from the AC power supply 110, a motor 130 for driving the electric vehicle, an inverter 140 for allowing the motor to be driven and a high voltage battery 150 to receive charge power, a connector 170 to which at least one connection device 180 is connected, a controller determining an operation mode of the inverter-charger integration apparatus on the basis of a signal input from the connection device 180 connected to the connector 170, and controlling the above-described components on the basis of the determined operation mode.

The rectifier 120 may rectify a single-phase AC power from the AC power supply 110 and provide the rectified power for charging the battery 150. The rectifier 120 may receive typical 220V single-phase AC power of typical household power supplies.

The motor 130 is for driving the electric vehicle and may perform a role of delivering DC power rectified through the rectifier 120 to the inverter 140. In addition, the motor 130 may be driven, in a driving mode, by receiving AC power converted from power charged in the high voltage battery 150 by a switching operation of the inverter 140.

The DC voltage converted through the rectifier 120 is provided to the inverter 140 through a coil of the motor 130.

The inverter 140 switches the DC power received through the motor 130 according to a switching signal and provides the DC power to the high voltage battery 150, and the high voltage battery 150 is charged by the DC power delivered by the switching operation of the inverter 140.

Furthermore, the inverter 140 converts the DC power charged in the high voltage battery 150 into three-phase AC power and provides the three-phase AC power to the motor 130 to drive the motor 130.

The high voltage battery 150 may be a fuel cell, generate a DC power in a scheme generating electrical energy through a chemical reaction of hydrogen (H2) and oxygen (O2) and accumulating the generated electrical energy in a stack, and be charged by the DC power received through a terminal of the battery.

A battery switch 160 intermittently connects power provided to or output from the high voltage battery 150.

That is, the inverter 140 converts DC power flowing through the motor 130 into charge power and provide the charge power to the high voltage battery 150 in a first operation mode (charging mode).

In addition, the inverter 140 converts the DC power charged in the high voltage battery 150 into three-phase AC power and provide the three-power AC power to the motor 130 in a second operation mode (driving mode).

The controller 190 determines an operation mode of the inverter 140 on the basis of signals input from the various connection devices 180 connected to the connector 170.

In addition, the controller 190 determines whether to start an operation and whether to stop the operation of the inverter 140 on the basis of signals input from the connection devices 180.

In conclusion, the controller 190 determines the operation mode of the inverter 140 and operation start time of the inverter 140 by using the signals input from the various connection devices 180 connected to the connector 170.

Here, the controller 190 determines the operation mode of the inverter 140 by using various conditions.

The various conditions include a state of an ignition key, a state of a charge switch, and a state of a controller area network (CAN) communication message and an input state of an AC power supply.

Furthermore, the controller 190 stores a plurality of tables and determines, from among the plurality of tables, a table to be used according to whether the connection device 180 is present.

The plurality of tables may include first to fourth tables.

That is, an ignition key switch 182 is necessarily connected to the connector 170. However, the charge switch 184 or a CAN communication module 188 may be selectively connected to the connector 170 according to whether to use it.

Accordingly, the plurality of tables include the first table to be used in the case where both the charge switch 184 and the CAN communication module 188 are connected to the connector 170, the second table to be used in the case where only the charge switch 184 is connected, the third table to be used in the case where only the CAN communication module 188 is connected, and the fourth table to be used in the case where none of them is connected.

Therefore, the controller 190 determines the operation mode by using any one table among the first to fourth tables according to a connection state of the connection devices.

Hereinafter, the operation of the controller 190 is described in detail.

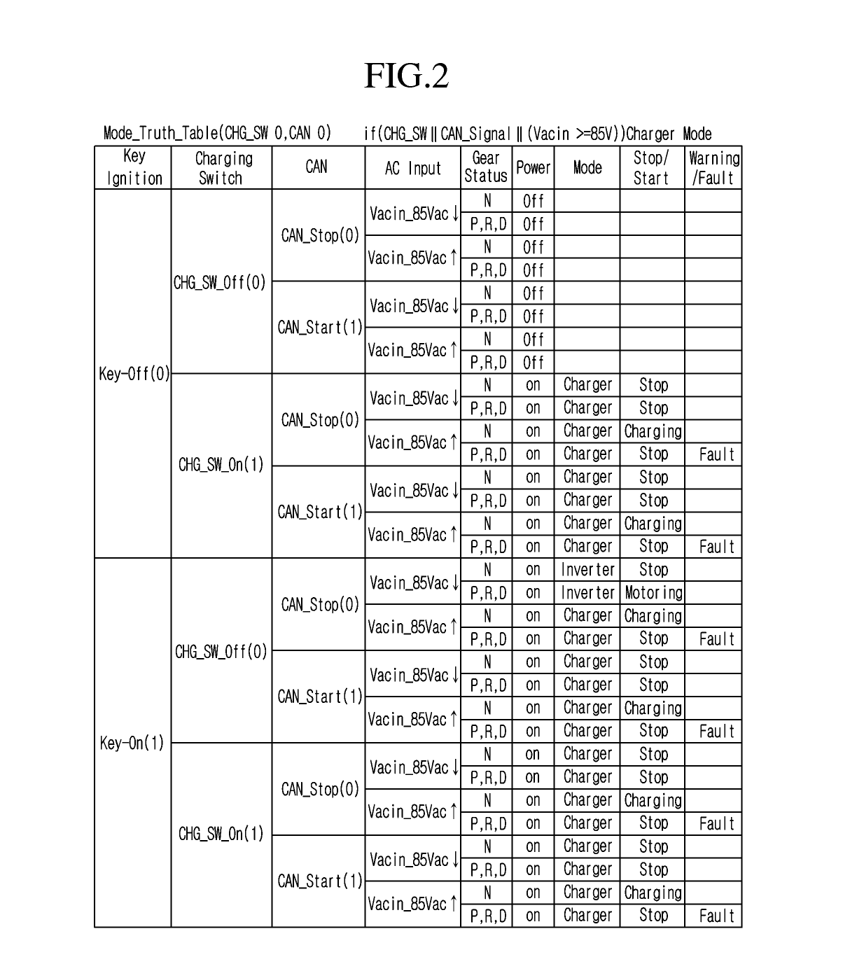

FIG. 2 illustrates the first table according to an embodiment.

The connection device 180 connected to the connector 170 may include the ignition switch 182, the charge switch 184, a warning signal generation unit 186, and the CAN communication module 188.

However, other connection devices besides the above-described connection device 180 may be connected to the connector 170. For example, an AC power detector (not shown) detecting an AC power level from the AC power supply 110 may be connected to the connector 170. In addition, a gear state detector detecting a current gear state (for example, neutral (N), parking (P), drive (D), and reverse (R)) may be further connected to the connector 170.

That is, when both the charge switch 184 and the CAN communication module 188 are connected to the connector 170, the controller 190 determines an operation mode of the inverter 140 by using the first table as shown in FIG. 2.

In other words, when the charge switch 184 and the CAN communication module 188 are connected to the connector 170, and both charge switching function and CAN communication function are supported, the controller 190 determines the operation mode of the inverter 140 by using the first table.

Accordingly, the controller 190 determines the operation mode of the inverter 140 on the basis of a communication state of the CAN communication module 188 and a detection state of the AC power detector.

That is, in an electric vehicle supporting the charge switch 184 and the CAN communication module 188, the controller 190 determines the operation mode of the inverter 140 on the basis of the states of the ignition key switch 182 and the charge switch 184, the communication state of the CAN communication module 188 and the detection state of the AC power detector.

Accordingly, the controller 190 preferentially confirms the states of the ignition key switch 182 and the charge switch 184.

Here, the state of the ignition key switch 182 may include a first state of notifying Key-On and a second state of notifying Key-Off.

In addition, the state of the charge switch 184 may include a first state of notifying charging start and a second state of notifying charging stop.

The controller 190 confirms whether the each of the states of the ignition key switch 182 and the charge switch 184 is the first state or the second state.

When at least any one of the ignition key switch 182 and the charge switch 184 is in the first state, the controller 190 allows the inverter 140 to receive driving power.

When both the ignition key switch 182 and the charge switch 184 are in the second state, the controller 190 blocks the driving power provided to the inverter 140.

When at least any one of the ignition key switch 182 and the charge switch 184 is in the first state, the controller 190 allows the inverter 140 to receive driving power.

Then, when the ignition key switch 182 and the charge switch 184 are in a state for supplying the driving power to the inverter 140, the controller 190 determines the operation mode of the inverter 140 by combining the state of the charge switch, the communication state of the CAN communication module and an input level of the AC power.

That is, the controller 190 confirms whether at least one of the state of the charge switch, the communication state of the CAN communication module and the input level of the AC power is in a state for performing the charging operation.

In other words, the controller 190 determines whether the state of the charge switch is the first state corresponding to an On state, a charge request communication message is received through the CAN communication module, or the input level of the AC power is greater than a preset reference value (normal AC power is input).

When the state of the charge switch, the communication state of the CAN communication module and the input level of the AC power is in the state for performing the charging operation, the controller 190 sets the operation mode of the inverter 140 to be the charging mode.

In addition, when all the state of the charge switch, the communication state of the CAN communication module and the input level of the AC power are not the state for performing the charging operation, the controller 190 sets the operation mode of the inverter 140 to be the driving mode.

Accordingly, only when the state of charge switch state is an Off state, the charge request message is not received through the CAN communication module and the input level of the AC power is not greater than the preset reference value, the operation mode of the inverter 140 is set to the driving mode, and set to the charging mode in the rest of cases.

In addition, the controller 190 confirms a gear shift state and controls so that the inverter 140 operates in correspondence to the operation mode set on the basis of the gear shift state.

That is, when the operation mode of the inverter 140 is set to the charging mode, the controller 190 drives the inverter 140 only when the gear shift state is in neutral and allows the high voltage battery 190 to be charged, and outputs a warning message when the gear shift state is another state except the neutral state.

When the operation mode of the inverter 140 is set to the driving mode, the controller 190 stops the motor when the gear shift state is in neutral and drives the motor 130 in the rest of states.

As described above, the controller 190 determines the operation mode of the inverter 140 through combination of various conditions and determines operation start or operation stop of the inverter by using the gear state, thereby increasing stability.

According to the embodiment described above, stability and a customer satisfaction index of the electric vehicle may be increased by solving various issues occurring when the inverter and the charger, which have been separately operated, are integrated into one.

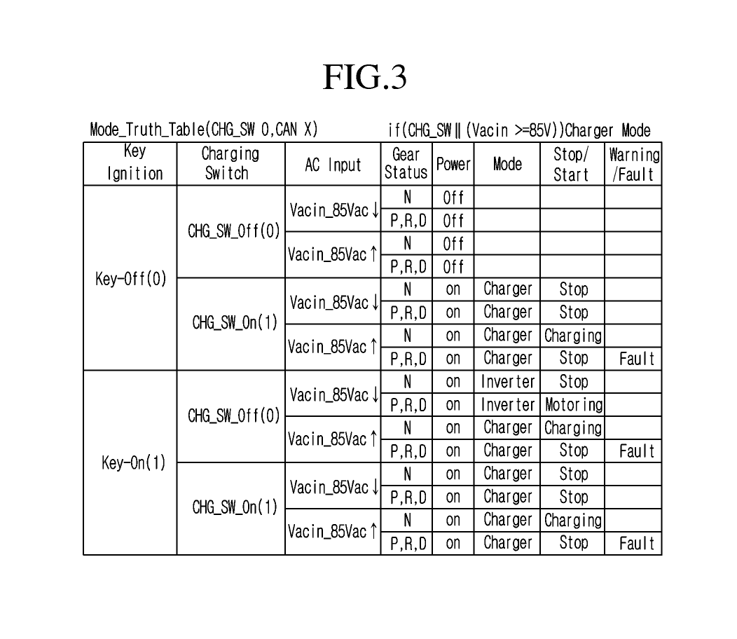

FIG. 3 illustrates the second table according to an embodiment,

The connection device 180 connected to the connector 170 may include the ignition key switch 182, the charge switch 184 and the warning signal generating unit 186, differently from the description in relation to FIG. 2.

That is, when only the charge switch 184 is connected to the connector 170, the controller 190 determines the operation mode of the inverter 140 by using the second table as shown in FIG. 3.

In other words, when only the charge switch 184 is connected to the connector 170 and accordingly only the charge switching function is supported, the controller 190 determines the operation mode of the inverter 140 by using the second table.

That is, the controller 190 confirms the states of the ignition key switch 182 and the charge switch 184.

Here, the state of the ignition key switch 182 may include a first state of notifying Key-On, and a second state of notifying Key-Off.

The state of the charge switch 184 may also include a first state of notifying the charge start and a second state of notifying the charge stop.

The controller 190 confirms whether each of the states of the ignition key switch 182 and the charge switch 184 is the first state or the second state.

When at least any one of the ignition key switch 182 and the charge switch 184 is in the first state, the controller 190 allows the inverter 140 to receive the driving power.

When both the ignition key switch 182 and the charge switch 184 are in the second state, the controller 190 blocks the driving power from being provided to the inverter 140.

When the states of the ignition key switch 182 and the charge switch 184 are in a state for supplying power voltage to the inverter 140, the controller 190 determines the operation mode of the inverter 140 by combining the charge switch state and the input level of the AC power.

That is, the controller 190 confirms whether at least one of the state of the charge switch and the input level of the AC power is in a state for performing the charging operation.

In other words, the controller 190 determines whether the state of the charge switch is the first state corresponding to an On state, or the input level of the AC power is greater than a preset reference value (normal AC power is input).

When at least one of the state of the charge switch and the input level of the AC power is in the state for performing the charging operation, the controller 190 sets the operation mode of the inverter 140 to be the charging mode.

In addition, when both the state of the charge switch and the input level of the AC power are not in the state for performing the charging operation, the controller 190 sets the operation mode of the inverter 140 to be the driving mode.

Accordingly, only when the charge switch state is an Off state and the input level of the AC power is not greater than the preset reference value, the operation mode of the inverter 140 is set to the driving mode, and set to the charging mode in the rest of cases.

In addition, the controller 190 confirms a gear shift state and controls so that the inverter 140 operates in correspondence to the operation mode set on the basis of the gear shift state, similarly to the description in relation to the first table.

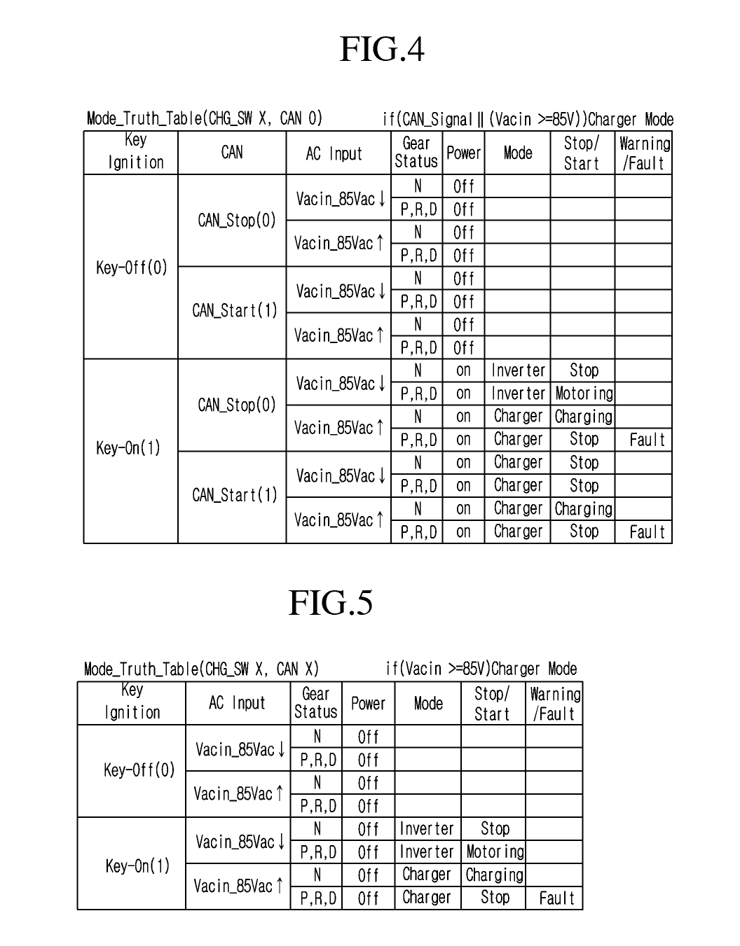

FIG. 4 illustrates the third table according to an embodiment.

The connection device 190 connected to the connector 170 may include the ignition key switch 182, the warning signal generating unit 186, and the CAN communication module 188.

That is, when only the CAN communication module 188 is connected to the connector 170, the controller 190 determines the operation mode of the inverter 140 by using the third table as shown in FIG. 4.

In other words, when only the CAN communication module 188 is connected to the controller 170 and only the CAN communication function is supported, the controller 190 determines the operation mode of the inverter 140 by using the third table.

Accordingly the controller 190 determines the operating mode of the inverter 140 on the basis of a state of the ignition key switch 182, a communication state of the CAN communication module 188, and a detections state of the AC power detector.

That is, in an electric vehicle supporting only the CAN communication module 188, the controller 190 determines the operation mode of the inverter 140 on the basis of the state of the ignition key switch 182, the communication state of the CAN communication module 188 and the detection state of the AC power detector.

Accordingly, the controller 190 preferentially confirms the state of the ignition key switch 182.

Here, the state of the ignition key switch 182 may include a first state of notifying Key-On and a second state of notifying Key-Off.

The controller 190 confirms whether the state of the ignition key switch 182 is the first state or the second state.

When the ignition key switch 182 is in the first state, the controller 190 allows the inverter 140 to receive the driving power.

When the ignition key switch 182 is in the second state, the controller 190 blocks the driving power voltage from being provided to the inverter 140.

Furthermore, when the state of the ignition key switch 182 is in a state for supplying power voltage to the inverter 140, the controller 190 allows the inverter 140 to receive the driving power and then determines the operation mode of the inverter 140 by combining the communication state of the CAN communication module and the input level of the AC power.

That is, the controller 190 confirms whether at least one of the state of the charge switch, the communication state of the CAN communication module and the input level of the AC power is in a state for performing the charging operation.

In other words, the controller 190 determines whether the charge request communication message is received through the CAN communication module, or the input level of the AC power is greater than a preset reference value (normal AC power is input).

When at least any one of the communication state of the CAN communication module and the input level of the AC power is in the state for performing the charging operation, the controller 190 sets the operation mode of the inverter 140 to be the charging mode.

In addition, when both the communication state of the CAN communication module and the input level of the AC power are not in the state for performing the charging operation, the controller 190 sets the operation mode of the inverter 140 to be the driving mode.

Accordingly, only when the charge request message is not received through the CAN communication module and the input level of the AC power is not greater than the preset reference value, the operation mode of the inverter 140 is set to the driving mode, and set to the charging mode in the rest of cases.

In addition, similarly to the description in relation to the first table, the controller 190 confirms a gear shift state and controls so that the inverter 140 operates in correspondence to the operation mode set on the basis of the gear shift state.

FIG. 5 illustrates the fourth table according to an embodiment.

That is, in an electric vehicle not supporting the charge switch 184 and the CAN communication module 188, the controller 190 determines the operation mode of the inverter 140 by using the fourth table as shown in FIG. 5.

A condition according to the fourth table includes only the states of the ignition key switch 182 and the input AC power.

Accordingly, the controller 190 preferentially detects the state of the ignition key switch 182. The state of the ignition key switch 182 may include a first state of notifying Key-On and a second state of notifying Key-Off.

The controller 190 confirms whether the state of the ignition key switch 182 is the first state or the second state.

When the ignition key switch 182 is in the second state, the controller 190 stops the operation of the inverter 140 since the driving of the electric vehicle is stopped.

At this time, the inverter 140 is in a state of being blocked from the driving power. That is, the state of the ignition key switch 182 is used as a condition for determining to provide the driving power voltage to the inverter 140.

Then, when the state of the ignition key switch 182 is the first state, the controller 190 provides the driving power to the inverter 140 and accordingly confirms an input state of the AC power. In addition, the controller 190 determines whether the AC power is input in a preset level of a reference value or greater or smaller than the reference value.

Here, the reference value may be 85 Vac. That is, typically the AC power has an input level of 110V or 220V. However, the input level of the AC power may have an error range, and accordingly the controller 190 determines whether the AC power is currently input in consideration of the error range of the AC power.

That, when the currently used AC power is 220V, the reference value may be 175 Vac, which is 80% of 220V, and when the currently used AC power is 110V, the reference value may be 85 Vac.

Accordingly, the controller 190 determines whether the AC power is currently input, in other words, whether a charging plug for charging is connected by using the reference value set as the above-described.

When the input level of the AC power is greater than the preset reference, the controller 190 determines preparation for charging is completed and sets the operation mode of the inverter 140 to be the charging mode. Accordingly, the inverter 140 performs the switching operation on the basis of a first switching signal provided for the charging operation. Here, the first switching signal may be generated in the charging signal generating unit for operation of the charger and output.

When the input level of the AC power is not greater than the preset reference value, the operation mode of the inverter 140 is set to the driving mode. Accordingly, the inverter performs switching operation on the basis of a second switching signal provided for driving the motor. Here, the second switching signal may be generated in the motor driving signal generating unit for driving the motor and output.

In addition, the controller determines whether to start an operation of the inverter 140 by using the current gear shift state in the state where the operation mode of the inverter 140 is determined.

That is, when the operation mode of the inverter 140 is the charging mode, the controller 190 allows the charging operation to be performed by the inverter 140 only when the gear shift state is in neutral, and stops the operation of the inverter 140 for the rest of the states except the neural state of the gear shift.

Here, the controller 190 generates a warning signal when the gear shift state is any one of P, R, and D for driving the motor in a state where the operation mode of the inverter 140 is set to the charging mode for the charging operation.

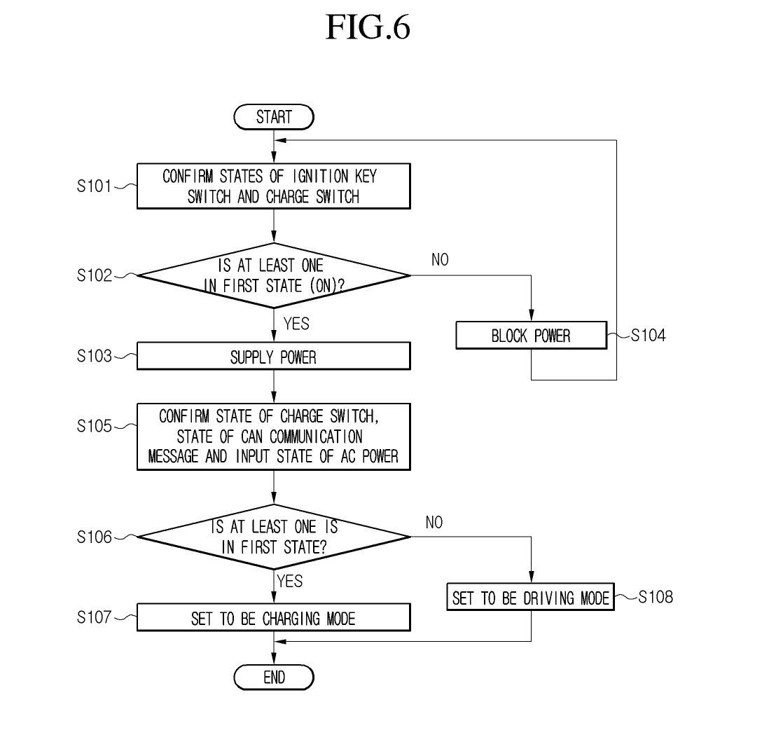

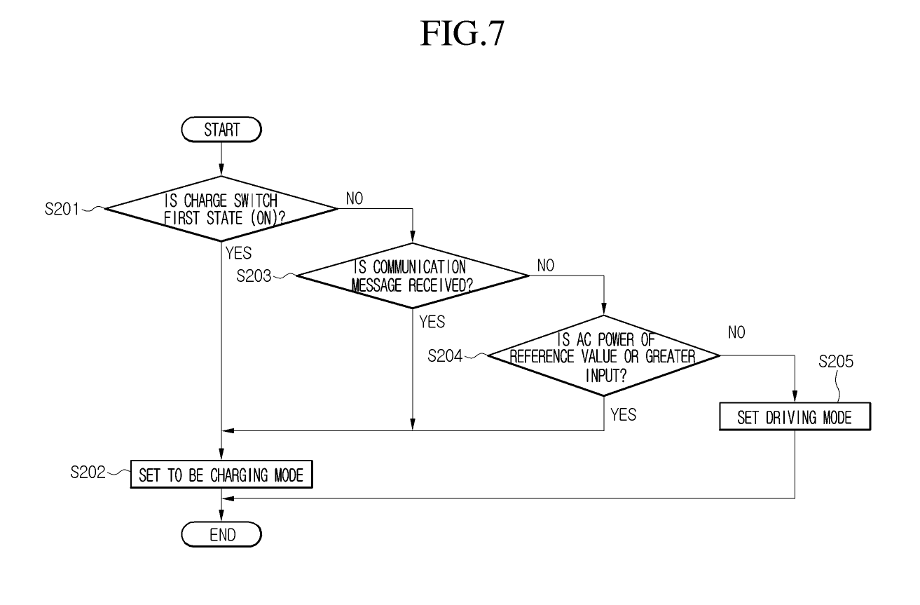

FIG. 6 is a flowchart illustrating an operation method of an inverter-charger integration apparatus for an electric vehicle according to a first embodiment for each operation. FIG. 7 is a detailed flow chart of operation 106 of FIG. 6.

Referring to FIG. 6, the controller 190 confirms the states of the ignition key switch 182 and the charge switch 184 (operation 101). That is, the controller 190 determines whether the ignition key switch 182 is in the first state corresponding to Key-On or in the second state corresponding to Key-Off. In addition, the controller 190 determines whether the charge switch 184 is in the first state for notifying the charging start or the second state for notifying the charging stop. The charging start corresponds to the case where the charge switch 184 is in an On state, and the charging stop corresponds to the case where the charge switch 184 is in an Off-state.

Then, the controller 190 determines whether at least any one of the confirmed states of the ignition key switch 182 and the charge switch 184 is in the first state (operation 102).

As the determination result (operation 102), when the at least one of the confirmed states of the ignition key switch 182 and the charge switch 184 is in the first state, the controller 190 provides the driving power to the charger-inverter integration apparatus for an electric vehicle (operation 103).

As the determination result (operation 102), when both the confirmed states of the ignition key switch 182 and the charge switch 184 are the second state, the controller 190 blocks the driving power voltage from being provided to the charger-inverter integration apparatus for an electric vehicle (operation 104).

Then, the controller 190 confirms the state of the charge switch 184, the communication state of the CAN communication module, and the input level of the AC power from the AC power supply 110 (operation 105). That is, the controller 190 confirms whether the CAN communication module is in the first state where a charge request communication message is received or in the second state where the charge request communication message is not received.

In addition, the controller 190 confirms whether a charging plug is connected to the AC power supply 110 and the AC power is currently input through the charging plug, or the charging plug is not connected and the AC power is not currently input.

The controller 190 determines whether at least one of the confirmed state of the charge switch 184, the communication state of the CAN communication module and the input level of the AC power is the first state for notifying the charging operation (operation 106).

As the determination result (operation 106), when the charge switch state is in the first state, the communication state of the CAN communication module is the first state, or the input level of the AC power is greater than the preset reference value, the controller 190 sets the operation mode of the inverter 140 to the charging mode (operation 107). That is, the controller 190 allows the rectifier 120 to rectify the input AC power from the AC power supply 110 and the inverter 140 to convert the rectified AC power into the charge power of the high voltage battery 150.

In addition, as the determination result (operation 106), when the charge switch state is the second state, the communication state of the CAN communication module is the second state, and the input level of the AC power is the preset reference value or smaller, the controller 190 sets the operation mode of the inverter 140 to the driving mode (operation 108). That is, the controller 190 allows the inverter 140 to convert the DC power stored in the high voltage battery 150 into the three-phase AC power and provides the three-phase AC power to the motor 130.

Hereinafter, the operation 106 is described in detail.

Referring to FIG. 7, the controller 190 confirms the state of the charge switch 184 is the first state corresponding to an On-state (operation 201).

Then, as the determination result (operation 201), when the state of the charge switch 184 is the first state, the controller 190 sets the operation mode of the inverter 140 to the charging mode (operation 202).

Moreover, as the determination result (operation 201), when the state of the charge switch 184 is the second state, the controller 190 determines whether a communication message notifying charging state through the CAN communication module is received (operation 203).

As the determination result (operation 203), when the communication message notifying charging state through the CAN communication module is received, the controller 190 proceeds to operation 202 and sets the operation mode of the inverter 140 to the charging mode.

On the other hand, as the determination result (operation 203), when the communication message is not received through the CAN communication module, the controller 190 determines whether the input level of the AC power is greater than the preset reference value (operation 204).

As the determination result (operation 204), when the input level of the AC power is greater than the preset reference value, the controller 190 proceeds to operation 202 and set the operation mode of the inverter 140 to the driving mode (operation 205).

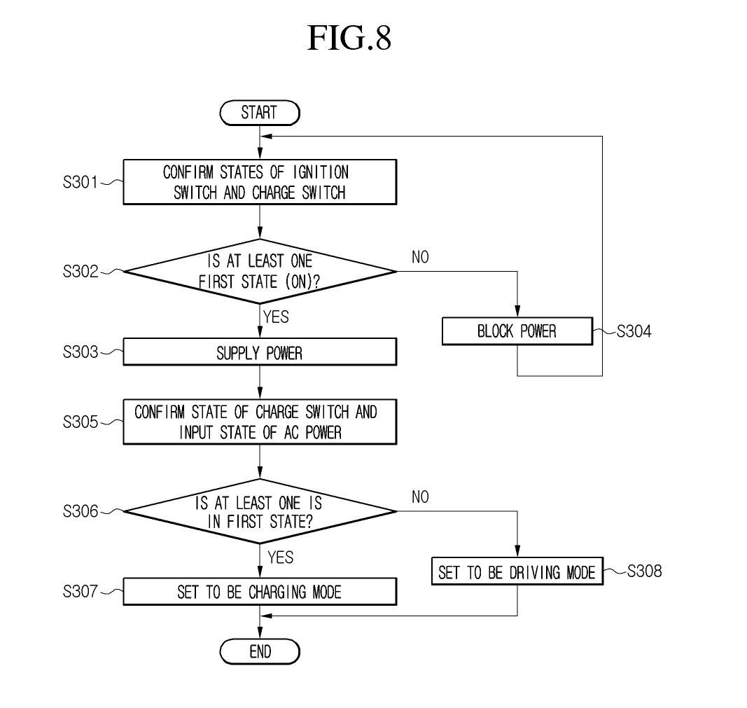

FIG. 8 is a flowchart illustrating an operating method of an inverter-charger integration apparatus according to a second embodiment.

Referring to FIG. 8, the controller 190 confirms the states of the ignition key switch 182 and the charge switch 184 (operation 301). That is, the controller 190 determines whether the ignition key switch 182 is in the first state corresponding to Key-On or in the second state corresponding to Key-Off. In addition, the controller 190 determines whether the charge switch 184 is in the first state for notifying the charging start or the second state for notifying the charging stop. The charging start corresponds to a case where the charge switch 184 is in an On-state, and the charging stop corresponds to a case where the charge switch 184 is in an Off-state.

Then, the controller 190 determines whether at least any one of the confirmed states of the ignition key switch 182 and the charge switch 184 is in the first state (operation 302).

As the determination result (operation 302), when the at least one of the confirmed states of the ignition key switch 182 and the charge switch 184 is the first state, the controller 190 provides the driving power to the charger-inverter integration apparatus for an electric vehicle (operation 303).

As the determination result (operation 302), when both the confirmed states of the ignition key switch 182 and the charge switch 184 are the second state, the controller 190 blocks the driving power voltage from being provided to the charger-inverter integration apparatus for an electric vehicle (operation 304).

Then, the controller 190 confirms the state of the charge switch 184 and the input level of the AC power from the AC power supply 110 (operation 305).

That is, the controller 190 confirms whether a charging plug is connected to the AC power supply 110 and the AC power is currently input through the charging plug, or the charging plug is not connected and the AC power is not currently input.

The controller 190 determines whether at least one of the state of the confirmed charge switch 184 and the input level of the AC power is the first state for notifying the charging operation (operation 306).

As the determination result (operation 306), when the charge switch state is in the first state or the input level of the AC power is greater than the preset reference value, the controller 190 sets the operation mode of the inverter 140 to the charging mode (operation 307). That is, the controller 190 allows the rectifier 120 to rectify the input AC power from the AC power supply 110 and the inverter 140 to convert the rectified AC power into the charge power of the high voltage battery 150.

In addition, as the determination result (operation 306), when the charge switch state is the second state and the input level of the AC power is the preset reference value or smaller, the controller 190 sets the operation mode of the inverter 140 to the driving mode (operation 308). That is, the controller 190 allows the inverter 140 to convert the DC power stored in the high voltage battery 150 into the three-phase AC power and provides the three-phase AC power to the motor 130.

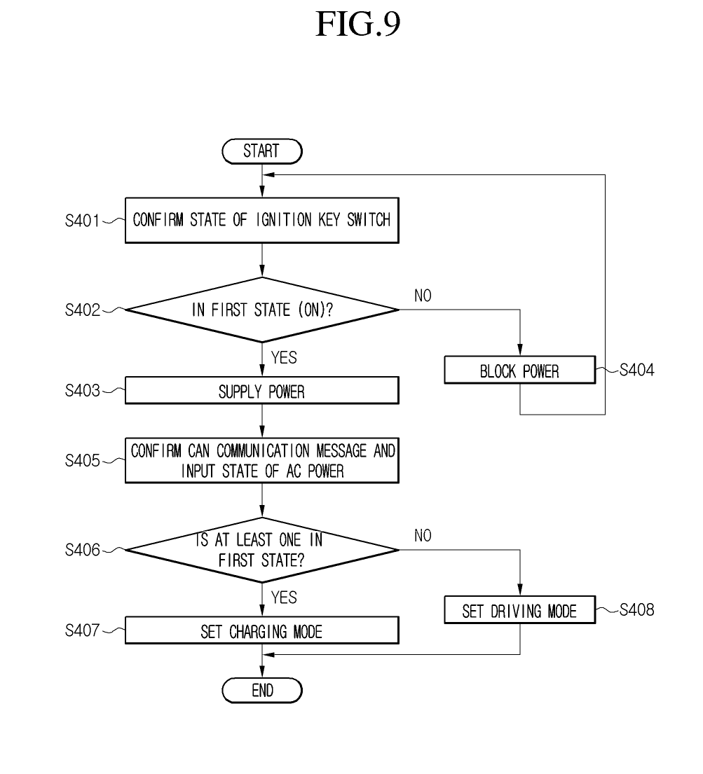

FIG. 9 is a flowchart illustrating an operating method of an inverter-charger integration apparatus for an electric vehicle according to a third embodiment.

Referring to FIG. 9, the controller 190 confirms the state of the ignition key switch 182 (operation 401). That is, the controller 190 determines whether the ignition key switch 184 is in the first state corresponding to Key-On or in the second state corresponding to Key-Off.

Then, the controller 190 determines whether the confirmed ignition key switch 182 is in the first state (operation 402).

As the determination result (operation 402), when the confirmed ignition key switch 182 is the first state, the controller 190 provides the driving power voltage to the charger-inverter integration apparatus for an electric vehicle (operation 403).

As the determination result (operation 402), when the confirmed state of the ignition key switch 182 is the second state, the controller 190 blocks the driving power voltage from being provided to the charger-inverter integration apparatus for an electric vehicle (operation 404).

Then, the controller 190 confirms the communication state of the CAN communication module and the input level of the AC power from the AC power supply 110 (operation 405). That is, the controller 190 confirms whether the CAN communication module is in the first state where a charge request communication message is received or in the second state where the charge request communication message is not received.

In addition, the controller 190 confirms whether a charging plug is connected to the AC power supply 110 and the AC power is currently input through the charging plug, or the charging plug is not connected and the AC power is not currently input.

The controller 190 determines whether at least one of the communication state of the CAN communication module and the input level of the AC power is in the first state for notifying the charging operation (operation 406).

As the determination result (operation 406), when the communication state of the CAN communication module is the first state, or the input level of the AC power is greater than the preset reference value, the controller 190 sets the operation mode of the inverter 140 to the charging mode (operation 407). That is, the controller 190 allows the rectifier 120 to rectify the input AC power from the AC power supply 110 and the inverter 140 to convert the rectified AC power into the charge power of the high voltage battery 150.

In addition, as the determination result (operation 406), when the communication state of the CAN communication module is the second state and the input level of the AC power is the preset reference value or smaller, the controller 190 sets the operation mode of the inverter 140 to the driving mode (operation 408). That is, the controller 190 allows the inverter 140 to convert the DC power stored in the high voltage battery 150 into the three-phase AC power and provides the three-phase AC power to the motor 130.

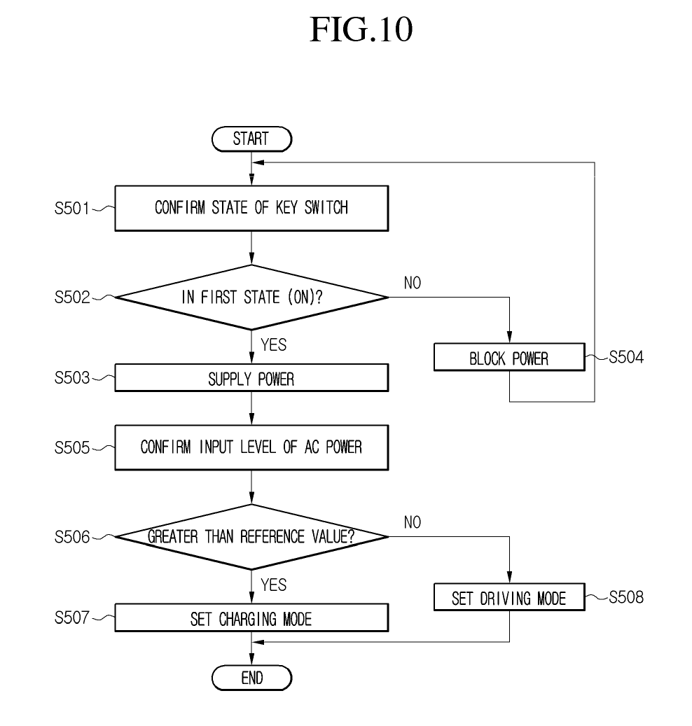

FIG. 10 illustrates a flowchart illustrating an operation method of an inverter-charger integration apparatus for an electric vehicle according to a fourth embodiment.

Referring FIG. 10, the controller 190 confirms the state of the ignition key switch 182 (operation 501). That is, the controller 190 determines whether the ignition key switch 182 is in the first state corresponding to Key-On or in the second state corresponding to Key-Off.

Then, the controller 190 determines whether the confirmed state of the ignition key switch 182 is in the first state (operation 502).

As the determination result (operation 502), when the confirmed state of the ignition key switch 182 is the first state, the controller 190 provides the driving power to the charger-inverter integration apparatus for an electric vehicle (operation 503).

As the determination result (operation 502), when the confirmed state of the ignition key switch 182 is the second state, the controller 190 blocks the driving power from being provided to the charger-inverter integration apparatus for an electric vehicle (operation 504).

Then, the controller 190 confirms the input level of the AC power (operation 505). That is, the controller 190 confirms whether a charging plug is connected to the AC power supply 110 and the AC power is currently input through the charging plug, or the charging plug is not connected and the AC power is not currently input.

The controller 190 determines whether the confirmed input level of the AC power is greater than the preset reference value (operation 506). That is, the controller 190 confirms whether the level of the input AC power is greater than 85 Vac.

Then, as the determination result (operation 506), when the input level of the AC power is greater than the preset reference value, the controller 190 sets the operation mode of the inverter 140 to the charging mode (operation 507). That is, the controller 190 allows the rectifier 120 to rectify the input AC power from the AC power supply 110 and the inverter 140 to convert the rectified AC power into the charge power of the high voltage battery 150.

In addition, as the determination result (operation 506), when the input level of the AC power is the preset reference value or smaller, the controller 190 sets the operation mode of the inverter 140 to the driving mode (operation 508). That is, the controller 190 allows the inverter 140 to convert the DC power stored in the high voltage battery 150 into the three-phase AC power and provides the three-phase AC power to the motor 130.

Hereinafter, an operation method for each of the charging mode and the driving mode is described.

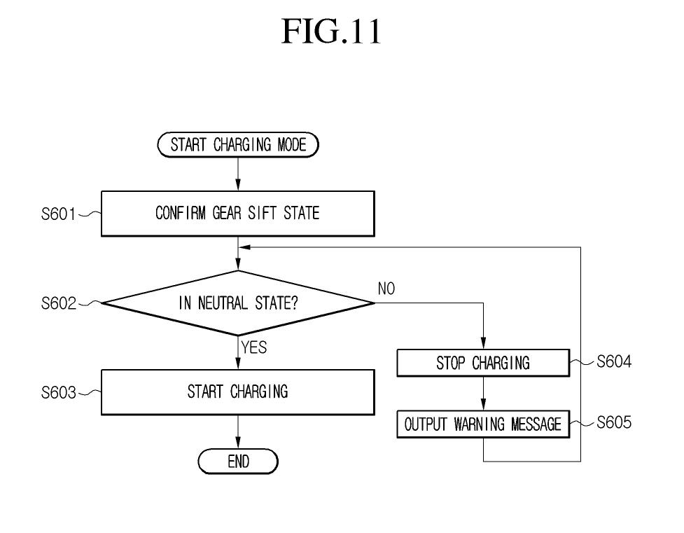

Referring to FIG. 11, the controller 190 sets the operation mode of the inverter 140 to the charging mode, and accordingly confirms the gear shift state (operation 601). That is, the controller 190 confirms whether the gear shift state is in neutral or a remaining state (parking, drive or reverse) except the neutral state.

Then, the controller 190 determines whether the confirmed gear shift is in neutral (operation 602).

As the determination result (operation 602), when the confirmed gear state is in neutral, the controller 190 allow the charge power to be provided to the high voltage battery 150 by operating the inverter 140 to allow the charging operation to be started.

In addition, as the determination result (operation 602), the confirmed gear state is in the remaining state except the neutral state, the controller 190 stops the operation of the inverter 140 (operation 604).

Furthermore, the controller 190 outputs a warning message that the gear shift state is required to be changed into the neutral state for charging the high voltage battery 150 (operation 605).

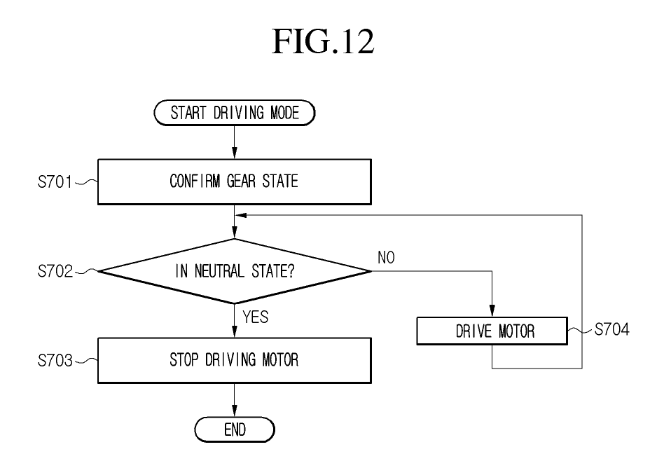

Then, referring to FIG. 12, the controller 190 sets the operation mode of the inverter 140 to the driving mode, and accordingly confirms the gear shift state (operation 701). That is, the controller 190 confirms whether the gear shift state is in neutral or the remaining state (parking, drive, or reverse) except the neutral state.

Then, the controller 190 determines whether the confirmed gear shift is in neutral (operation 702).

As the determination result (operation 702), when the confirmed gear shift is in neutral, the controller 190 stops the operation of the inverter 140 and prevents the motor 130 from being driven (operation 703).

In addition, as the determination result (operation 702), when the confirmed gear shift is the remaining state except the neutral state, the controller 190 operates the inverter 140 and allows the driving power voltage to be provided to the motor 130 (operation 704).

According to embodiments of the present invention, stability and a customer satisfaction index of an electric vehicle can be increased by solving various issues occurring when an inverter and a charger, which have been separately operated, are integrated into one.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An operating method of an inverter-charger integration device for an electric vehicle, the operating method comprising:
confirming whether a charge switch and a controller area network (CAN) communication module are used;
when both the charge switch and the CAN communication module are in use, determining an operation mode of an inverter by using a first table;
when only the charge switch is in use, determining the operation mode of the inverter by using a second table;
when only the CAN communication module is in use, determining the operation mode of the inverter by using a third table; and
when both the charge switch and the CAN communication module are not in use, determining the operation mode of the inverter by using a fourth table.

2. The operating method according to claim 1, wherein the determining of the operation mode of an inverter by using the first table comprises,
confirming states of an ignition key switch and the charge switch;
when at least one of the states of the ignition key switch and the charge switch is a first state corresponding to an On-state, providing driving power to the inverter;
when the driving power is provided, confirming the state of the charge switch, a state of the CAN communication module, and an input state of AC power; and
determining the operation mode of the inverter according to the confirmation result.

3. The operation method according to claim 2, wherein the determining of the operation mode of the inverter according to the confirmation result comprises,
determining the operation mode of the inverter according to the confirmed states;
when the state of the charge switch is the first state corresponding to the On-state, a communication state of the CAN communication module is a first state where a charge request communication message is received, or the input state of the AC power is a first state where normal AC power is input;
when at least one of the state of the charge switch, the communications state of the CAN communication module, and the input state of the AC power is the first state, determining the operation mode of the inverter to a charging mode; and
when all of the state of the charge switch, the communication state of the CAN communication module, and the input state of the AC power are the second state which is opposite to the first state, determining the operation mode of the inverter to a driving mode.

4. The operation mode according to claim 1, wherein the determining of the operation mode of the inverter by using the second table comprises,
confirming a state of the ignition key switch and the state of the charge switch;
when at least one of the states of the ignition key switch and the charge switch is a first state corresponding to an On-state, providing driving power to the inverter;
when the driving power is provided, determining whether the state of the charge switch is the first state corresponding to the On-state, or an input state of the AC power is a first state where normal AC power is input;
when at least one of the state of the charge switch and the input state of the AC power is the first state, determining the operation mode of the inverter to a charging mode; and
when both the state of the charge switch and the input state of the AC power is the second state, which is opposite to the first state, setting the operation mode of the inverter to a driving mode.

5. The operation method according to claim 1, wherein the determining of the operation mode of the inverter by using the third table comprises,
confirming an ignition key switch;
when a state of the ignition key switch is a first state corresponding to an On-state, providing driving power to the inverter;
when the driving power is supplied, determining whether a communication state of the CAN communication module is a first state in which a charge requesting communication message is received or a second state in which the AC power is normally input;
when at least one of the CAN communication module and the input state of the AC power is the first state, determining the operation mode of the inverter as a charging mode; and
when both the CAN communication module and the input state of the AC power are the second state which is opposite to the first state, setting the operation mode of the inverter as a driving mode.

6. The operation method according to claim 1, wherein the determining of the operation mode of the inverter by using the fourth table comprises,
confirming an ignition key switch;
when a state of the ignition key switch is a first state corresponding to an On-state, providing driving power to the inverter;
when the driving power is supplied, confirming the input state of the AC power;
when the input state of the AC power is in a first state where the AC power is normally input, determining the operation mode of the inverter as a charging mode;
when the input state of the AC power is a second state which is opposite to the first state, setting the operation mode of the inverter as a driving mode.

7. The operation method according to claim 1, further comprising, when the operation mode of the inverter is determined as the charging mode, providing charge power to a high voltage battery by using the inverter.

8. The operation method according to claim 7, wherein the providing of the charge power comprises,
confirming a gear shift state;
when the confirmed gear shift state is neutral, operating the inverter and providing the charge power to the high voltage battery; and
when the confirmed gear shift state is another state except the neutral state, stopping the operation of the inverter and stopping the charging operation.

9. The operation method according to claim 8, further comprising, when the confirmed gear shift state is another state except the neutral state, outputting a warning message,
wherein the warning message comprises a message requesting a state change of the gear shift for starting to charge the high voltage battery.

10. The operation method according to claim 1, wherein the first table is configured with the operation mode of the inverter to be determined according to combination of a state of an ignition key, a communication state of the CAN communication module and an input state of AC power,
the second table is configured with the operation mode of the inverter to be determined according to the state of the ignition key switch, the state of the charge switch, and the input state of the AC power,
the third table is configured with the operation mode of the inverter to be determined according to the state of the ignition key switch, the communication state of the CAN communication module and the input state of the AC power, and
the fourth table is configured with the operation mode of the inverter to be determined according to the state of the ignition key switch and the input state of the AC power.
